(19) United States
(12) Patent Application Publication
(10) Pub. No.: US 2009/0235170 A1
(43) Pub. Date: Sep. 17, 2009

(54) METHODS AND APPARATUS FOR SHARING EITHER A COMPUTER DISPLAY SCREEN OR A MEDIA FILE AND SELECTING THEREBETWEEN

(75) Inventors: Stuart Alan Golden, Portland, OR (US); Adi Ronen, Beaverton, OR (US)

Correspondence Address: STOEL RIVES LLP - PDX, 900 SW FIFTH AVENUE, SUITE 2600, PORTLAND, OR, 97204-1268, US

(73) Assignee: Golden Signals, Inc., Beaverton, OR (US)

(21) Appl. No.: 12/242,227

(22) Filed: Sep. 30, 2008

Related U.S. Application Data
(60) Provisional application No. 61/069,573, filed on Mar. 17, 2008.

(51) Int. Cl. G06F 3/048

(52) U.S. Cl. 715/719; 715/716

(57) ABSTRACT

A method selectively either (a) plays a media file accessed from a computer on a remote display device connected to a media adapter or (b) masquerades uncompressed pixel-level computer display screen graphics data as a media stream supported by the media adapter to cause the display device to substantially clone or extend what appears on at least a portion of a local display screen attached to the computer. The method senses when a user enters an input signifying a desire by the user to play a media file on the computer. If said input is not sensed, then the method performs a masquerading process to process, compress, and package the display screen graphics data as a media stream and then transmits the media stream to the media adapter. If said input is sensed, then the method transmits the media file to the media adapter.

### RELATED APPLICATIONS

Priority is claimed under 35 U.S.C. §119 to U.S. provisional application No. 61/069,573, filed Mar. 17, 2008, entitled “Method for Sending A/V Display of a Notebook to a Large Screen TV or Entertainment System,” which is incorporated by reference herein in its entirety.

Related subject matter is disclosed in U.S. patent application Ser. No. 12/182,929, filed Jul. 30, 2008, entitled “Methods and Apparatus for Sharing a Computer Display Screen,” which is incorporated by reference herein in its entirety.

### TECHNICAL FIELD

The field of this disclosure relates generally to computer graphics processing and selective visual display systems, and more particularly but not exclusively to plural display systems.

### BACKGROUND INFORMATION

Computer display screens typically require a physical connection to a computer either internally or externally via a cable and are predominantly designed to render a graphical user interface associated with one set of input devices connected to the computer. For these reasons, a computer display is usually dedicated to an individual user rather than a larger audience.

On the other hand, modern wide-audience media display devices, such as televisions and projectors, were developed specifically to accommodate larger groups in household living rooms, home theaters, or conference-room environments. Wide-audience media displays have developed independently from personal computers or computer displays and they are unencumbered by computer keyboards. Unfortunately, however, this separate development has also resulted in frequent incompatibility between computer displays and wide-audience displays, as they often lack a common standardized audio/visual (A/V) cable connection by which to connect a computer video output or they cannot properly accommodate the video resolutions of a computer display.

With digital media becoming increasingly accessible, more users are acquiring and collecting the media directly on their computers as opposed to via television broadcasts or tangible media specifically suited for wide-audience media displays and associated accessories. Increasingly, television viewers are choosing to time-shift television broadcasts to watch them on their computers, which are often portable, rather than their wide-audience display devices. All of these users are subsequently unable to easily enjoy the benefits of their wide-audience media display for their computer media.

Experiencing computer slide-show presentations, documents, or other computer media content on a wide-audience media display is at times a preferable way to experience A/V data, particularly in large-group settings. Compared with computer displays, wide-audience media displays offer the benefits of a larger display area, typically feature higher-quality sound systems, and are increasingly capable of displaying high-definition video content. Additionally, many wide-audience media displays are connected to network-centric accessories, e.g., video gaming systems, that enable the display of media files from remote media libraries residing on networked computers.

One technique that attempts to harness the benefits of wide-audience media displays for use to view computer media content relies on physically cabled connections. This technique has been facilitated by standardized A/V cable interfaces, but not every computer and wide-audience media display share a common cable connector. Furthermore, cabling also suffers from the cable's constraints: The cables have limited length; switching the cable to other computers to accommodate a multi-user model is cumbersome; and not all cable connections can support high bandwidth requirements. In general, those techniques lack mobility, dynamic computer display switching, and ease of use.

Other techniques that facilitate sharing computer display content on wide-audience media displays rely on proprietary dedicated wired or wireless connections from the computer to a wide-audience media display. According to those techniques, the computer initiates a specialized connection so that it can transmit media content for display on the wide-audience media display. Sometimes the connections are facilitated through an intermediate device that receives transmitted media content and provides a physical interface with a wide-audience media display via standardized A/V cables. Because these methods and systems are typically proprietary, interoperability is limited. Any computer attempting to transmit media content to the wide-audience media display must possess the specific proprietary hardware and software protocols required for transmission and reception of the media. In general, these techniques lack commonality and necessitate custom hardware.

### BRIEF DESCRIPTION OF THE DRAWINGS

FIG. 1 is a simplified diagram of an end-to-end system according to one embodiment.

FIG. 2 is a depiction of a computer system in the end-to-end system of FIG. 1, according to one physical form factor.

FIG. 3 is a high-level block diagram of the computer system in FIG. 2.

FIG. 4 is high-level block diagram of add-on hardware for the computer system in FIG. 2, according to one embodiment.

FIG. 5 is a simplified block diagram of a computer architecture according to one embodiment.

FIG. 6 is a computer memory diagram showing software modules and routines according to one embodiment.

FIG. 7 is a block diagram of aspects of a computer according to one embodiment.

FIG. 8 is a flowchart of a method according to one embodiment.

FIG. 9 is a flowchart of another method according to one embodiment.

### DETAILED DESCRIPTION OF EMBODIMENTS

With reference to the above-listed drawings, this section describes particular embodiments and their detailed construction and operation. The embodiments described herein are set forth by way of illustration only and not limitation. Those skilled in the art will recognize in light of the teachings herein that there are alternatives, variations and equivalents to the example embodiments described herein. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

### I. Overview

As one skilled in the art will appreciate in light of this disclosure, certain embodiments may be capable of achieving certain advantages, including, in some cases, some or all of the following: (1) sharing a desktop display or a classical media file with a large audience via a display suitable for wide-audience viewing; (2) utilizing existing media adapters to facilitate the transfer of the desktop graphics data or media file; (3) permitting a user of a local computer to initiate the display sharing feature by operation of a control at the local computer; (4) sharing associated audio with the graphics data and thereby taking advantage of a typically higher quality sound system associated with the wide-audience display device; (5) working well with content-protected media files in a manner that naturally fulfills the user's expectations; (6) allowing the user to select a portion of the desktop display for sharing, thereby permitting parts of the desktop to be kept private and decreasing processing and transmission bandwidth requirements; and (7) giving the user an option to share only audio content generated at the computer by playback on a wide-audience sound system. These and other advantages of various embodiments will be apparent upon reading this document.

According to one embodiment, a method selectively either (a) plays a media file accessed from a computer on a remote display device connected to a media adapter or (b) masquerades uncompressed pixel-level computer display screen graphics data as a media stream supported by the media adapter to cause the remote display device to substantially clone or extend what appears on at least a portion of a local display screen attached to the computer. The method senses when a user enters an input signifying a desire by the user to play a media file on the computer. If said input is not sensed, then the method performs a masquerading process comprising processing the display screen graphics data as the graphics data is generated by the computer, wherein the processing includes compressing, to yield processed display screen graphics data in a compressed format supported by the media adapter; packaging the processed display screen graphics data as a media stream; configuring the computer to be a media server of the media stream to the media adapter; and transmitting the media stream from the computer to the media adapter, thereby facilitating display on the display device of the graphics content. If said input is sensed, then the method performs a file transfer process comprising transmitting the media file from the computer to the media adapter, thereby facilitating display on the remote display device of the video content associated with the media file.

According to another embodiment, a computer system comprises a frame buffer, a local display screen connected to the frame buffer, a memory storing a media file, a transmitter, and a number of modules. The frame buffer stores pixel-level display screen graphics data. The local display screen is connected to the frame buffer. Images represented by the pixel-level display screen graphics data in the frame buffer are displayable on the local display screen when the computer system operates in a normal display mode. A module processes the display screen graphics data as the graphics data is generated, wherein the processing includes compressing, to yield processed display screen graphics data in a compressed format supported by a media adapter connected to a remote display device. A module packages the processed display screen graphics data as a media stream. Software configures the computer to be a media server of the media stream to the media adapter. The transmitter transmits to the media adapter either (a) the media stream, thereby substantially cloning or extending what appears on at least a portion of the local display screen on the remote display device, or (b) the media file, thereby causing the media adapter to play the media file on the remote display device. A module detects selection of the media file by the user and directs the media file to the transmitter if opened by the user but otherwise directs the media stream to the transmitter.

According to another embodiment, a method selectively plays on an A/V presentation device connected to a media adapter either (a) audio content of a media file accessed from a computer or (b) system audio content generated by operation of the computer. The method senses when a user enters an input signifying a desire by the user to play a media file on the computer. If said input is not sensed, then the method performs a masquerading process, which comprises processing system audio data generated by the computer during normal operation of the computer, wherein the processing includes compressing, to yield processed audio data in a compressed format supported by the media adapter; packaging the processed audio data as a media stream; configuring the computer to be a media server of the media stream to the media adapter; and transmitting the media stream from the computer to the media adapter, thereby facilitating playback on the A/V presentation device of the audio content. If said input is sensed, then the method performs a file transfer process comprising transmitting the media file from the computer to the media adapter, thereby facilitating playback on the A/V presentation device of the audio content associated with the media file.

According to another embodiment, a method masquerades a selected portion of uncompressed pixel-level computer display screen graphics data as a media stream supported by a media adapter connected to a remote display device, so as to cause the remote display device to display what appears on the selected portion of a local display screen attached to the computer. The method accepts a user-defined selection of a portion of the local display screen. The method processes display screen graphics data associated with the user-defined selection, as the graphics data is generated by the computer. The processing includes compressing, to yield processed display screen graphics data in a compressed format supported by the media adapter. The method packages the processed display screen graphics data as a media stream. The method configures the computer to be a media server of the media stream to the media adapter. The method transmits the media stream from the computer to the media adapter, thereby facilitating display on the remote display device of the graphics content.

According to yet other embodiments, computer-readable media can be embedded with program code for implementing any of the above methods, systems and apparatuses.

Additional details concerning the construction and operation of particular embodiments are set forth in the following subsections with reference to the above-listed drawings.

### II. Systems and Apparatuses

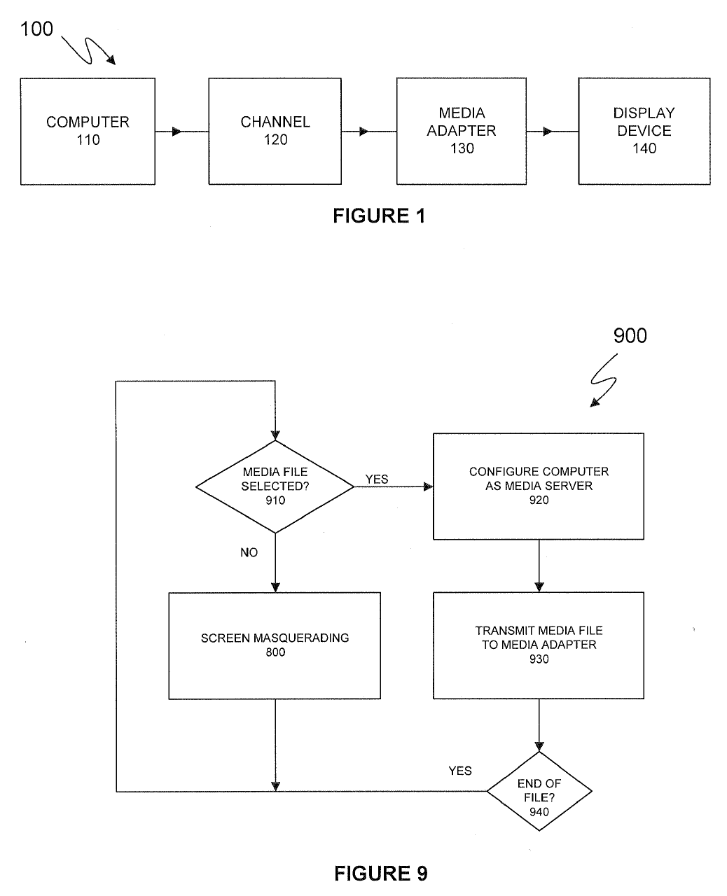

FIG. 1 is a simplified block diagram of an end-to-end system according to one embodiment. The end-to-end system 100 comprises a computer or computer system 110, a channel 120, a media adapter 130, and a display device 140. The system 100 is useful in sharing the video and/or audio content from the computer 110 with a potentially larger audience for whom the display device 140 is visible or more easily visible than the local display screen associated with the computer 110. The video content may be the same as or an extension of what is displayed on the local display screen associated with the computer 110, or it may derive from a media file on or from the computer 110. The display device 140 may be, for example, a television or a projector and is typically designed for use by multiple viewers. The display device 140 may be a standard-definition or high-definition device. More generally, the display device 140 may be a A/V presentation device with capabilities to playback video content, audio content, either or both. The system 100 may be located in a home living room, theatre, business office, conference room, or any other setting.

The computer 110 can masquerade its local display screen graphics data as a media stream to facilitate its display on the display device 140. The computer 110 sends that media stream or a classical media file to the media adapter 130. The media adaptor 130 has capabilities to receive a media stream or file from a remote computer, to process the received media stream as necessary (e.g., decompression), and to interface with the display device 140 to cause the display device 140 to display the video content represented by the media stream and to play the audio content, if any, represented by the media stream on a sound system attached to the media adapter. The media adapter 130 is preferably a pre-existing, standardized, non-proprietary device. The media adapter 130 may be a stand-alone device or may be integrated within another device, such as the display device 140 or a gaming system. Gaming systems that presently incorporate media adapters include the Xbox 360® system from Microsoft Corp. and the PlayStation® 3 system from Sony, Inc. Current televisions that include a media adapter include the Smartmedia TV from Hewlett-Packard Co. The media adapter 130 may be a Windows® media extender (WME) or Windows® media adapter (WMA) designed to operate with some versions of the Windows® operating system from Microsoft Corp.

The local display screen graphics data is typically uncompressed graphics data generated by the computer 110 and stored in a frame buffer within the computer 110. The frame buffer is a pixel-by-pixel data representation of the local display screen of the computer 110. The contents of the frame buffer represents what is shown on the local display screen. In some settings, what is shown on the local display screen is referred to as the “desktop” and may include such graphical objects as windows, icons, menus, bars and the like. The system 100 is capable of sharing the computer 110's desktop or a portion thereof and/or associated audio with a wider audience via the display device 140.

The computer 110 processes its local display screen graphics data as that data is generated, preferably on the fly. That processing includes compression into a format supported by the media adaptor 130. The computer 110 packages the processed graphics data as a media stream that is supported by the media adapter 130. The media stream is preferably a gapless MPEG (Motion Picture Experts Group) compliant data stream rendered by sampling the video output or frame buffer of the computer 110 and applying temporal and/or spatial compression algorithms, but any type of compression and/or media stream format supported by the media adapter 130 can be used. The computer 110 is configured to be a media server, serving the media stream to the media adapter 130. The media stream is thereafter received by the media adapter 130, decompressed, and passed to the display device 140 via a suitable display device physical interface.

In another mode of operation, the computer 110 can serve a media file to the media adapter 130 for playing on the remote display device 140. The media file 270 may be, for example, an audio-visual file, such as an MPEG file, an image file, such as a JPEG or TIFF file, or an audio file, such as an MP3 file. The media file 270 may be a “classical” media file, as distinguished from the display screen data, which is processed, compressed and packaged to be or to resemble a media stream or media file. The media file may be stored on the computer 110 or accessed by the computer 110, such as by downloading or streaming from a network, such as the Internet. The computer 110 can intelligently switch between remote display modes for (a) masquerading its desktop for remote display and (b) playing a classical media file, according to the techniques described herein.

As shown in FIG. 1, the computer 110 passes the media stream or file to the media adapter 130 via a transmission channel 120. The channel 120 may be hard-wired but is preferably wireless. The channel 120 preferably operates according to the Internet Protocol (IP). The channel 120 may comprise a LAN (Local Area Network, which may be wireless (WLAN). In one example, the channel 120 operates according to a WiFi wireless link operating according to an IEEE (Institute of Electronics and Electrical Engineers) 802.11 standard (e.g., 802.11n) and the media adapter may be an 802.11 access point. Alternatively, a combination of wired and wireless links may be used. For example, the computer may be connected to a wireless network via a 802.11a/b/g/n adapter but the media adapter may be connected via a wire (e.g., Ethernet cabling) to switches and/or access point(s). Thus, the interfaces on both sides of the channel 120 may not necessarily be homogenous. Alternatively, other wireless communication protocols, such as Bluetooth™ or Ultra-Wideband (UWB) may be employed. The computer 110 may register with the media adapter 130, or vice versa, by use of a discovery protocol, such as universal plug and play (UPnP).

Use of the system 100 permits display on the display device 140 of the desktop graphics data of the computer 110 or a media file. In a normal display mode, the desktop graphics data appears only on the local display screen associated with the computer 110. However, the system 100 can cause the same or related content to appear on the display device 140. According to one example of use, the display device 140 clones or substantially clones at least a portion of what appears on the local display screen of the computer 110. The local display screen may or may not be blanked, put into background mode or otherwise altered during this period of cloning. According to another example of use, the display device 140 becomes an extension of the local display screen of the computer 110 in the same or a similar way as a second local display screen can be configured to extend the primary display screen above, below, or in another direction.

Optionally, the computer 100 may permit the user to select just a portion of the local display screen for sharing. This may be desirable to a user who may have some content on his local display screen that he or she would prefer to keep private while other content is intended for displaying on the display device 140. According to one embodiment, when the user initiates display sharing, such as by pressing an activation key, the computer 100 queries the user, such as via a dialog box, whether the entire local display screen or just a portion of it should be shared. Alternatively, a setting can be configured in advance, such as through a suitable menu accessible in the control panel of the Windows® operating system, to default to either full screen or partial screen sharing. In any event, when partial screen sharing is selected, the computer 100 permits the user to define or select the desired portion to share. According to one example, the computer 100 displays a box on the local display screen. The box is movable and sizable by the user. The box may look like a television or a television screen or have indicia suggesting that it represents a television. After the user positions and sizes the box to contain the portion of the local display screen he or she desires to share, then the user signals completion of the selection, such as by clicking a mouse button or pressing a key. Then the computer proceeds to process only the pixels within the box for transmission to the media adapter 130 and subsequent display on the remote display device 140. An advantage of processing only a portion of the local display screen is that the processing and transmission bandwidth are decreased, as there are fewer pixels to process and transmit. A permissible portion of local display screen may be none, in which case only the audio generated by the computer 100 is sent to the media adapter and played though the sound system associated with the remote display device 140.

In the system 100, the computer 110 presents its desktop, or a portion thereof, to the media adapter 130, preferably in real time, as something that looks like a file to the media adapter 130 in a format that the media adapter 130 expects and accepts without the user needing to think about format compatibilities or nuances associated with a particular media adapter. In other words, the computer 110 converts its desktop video into a media stream or file that the media adapter 130 is designed to play. In this way, the computer 110 takes advantage of the existing capability of the media adapter and leverages that ability to provide new functionality—namely, sharing of the computer's local display. The media adapter 130 is not otherwise designed to display a computer desktop. The computer 110 appears to the media adapter 130 as an A/V media server with a single item (e.g., a WMP11 file) in its content directory. That item is the computer's desktop video. When the computer 110 publishes its content directory, the media adapter 130 sees the single file therein and requests it. The computer 110 then configures its compression parameters to match the media adapter's settings and sends the desktop in a compressed format according to those parameters.

The computer 110 may also generate audio data that is normally played on a speaker or speaker set (not shown) integrated within or electrically connected to the computer 110. The audio data is preferably also processed and transmitted along with the graphics data for playback on the display device 140 or associated equipment, which often features a higher quality sound system than typically found on a computer. The audio data may be processed separately from the graphics data or together. The audio data is preferably packaged with the video data as part of the same media stream transmitted to the media adapter 130.

It may sometimes be desirable for the user to share only the audio data from the computer 110. Typically, most wide-audience display devices have higher quality audio play capabilities than a computer, especially a notebook computer. Users may wish to take advantage of that higher quality audio system without sharing any screen, video, image data or the like. An audio-only option can be provided in many ways. For example, a video-disable or audio-only button on the computer 110 can be utilized to enter an audio-only mode. Alternatively, initiation of sharing mode can cause the computer 110 to generate a dialog box whereby the user can make an audio-only selection. That dialog box could be the same one that allows the user to choose the option to select just a portion of the local display screen to share, or it could be a separate dialog box. The audio-only mode could also be set-up as a default mode in a configuration accessible through the control panel in the Windows® operating system, for example.

Changeover from normal display mode to a remote display mode, in which the remote display device 140 is activated, may be initiated by action by the user of the computer 110. The initiating action may be depression of a keyboard button, such as a function key, or operation of a point-and-click device, such as a mouse. The computer 110 may run a background process to detect the action and to crossover in response. A disabling action, such as a subsequent depression of the same key, can cause the computer 110 to revert to the normal state.

The computer 110 may be one of several similarly operable computers, each of which is capable of operating together with the same media adapter 130 and remote display device 140 in the manner described above in relation to FIG. 1, as described in greater detail in patent application Ser. No. 12/182,929.

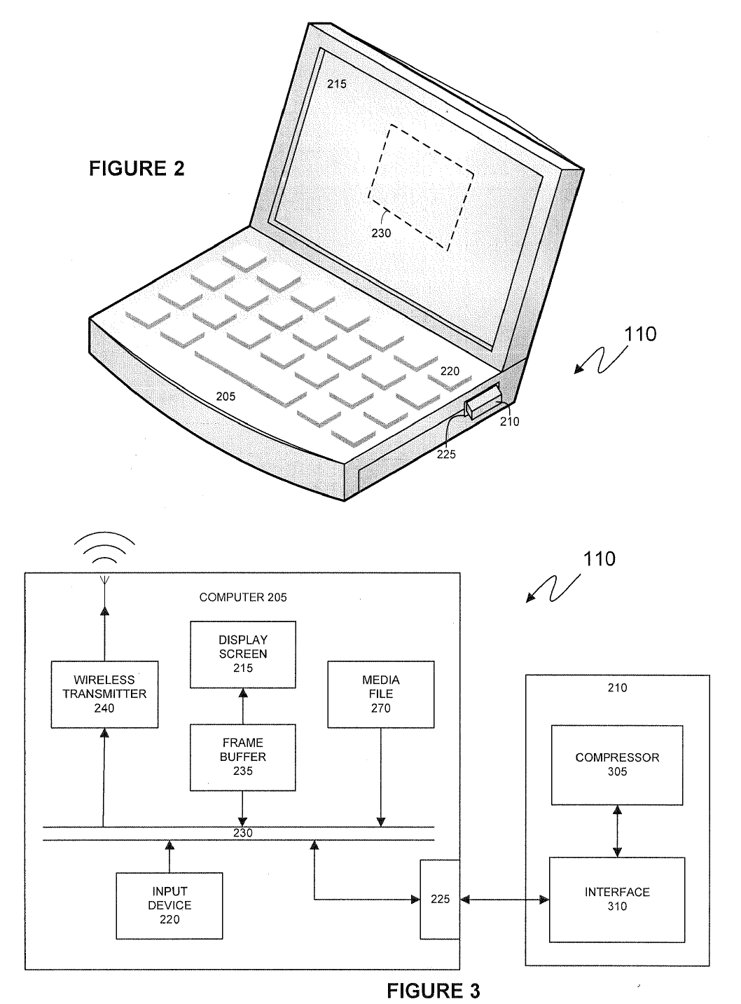

The computer 110 can take various forms, a representative example of which is illustrated in the FIG. 2 and described below. The computer 110 may be a computer per se or a computer system having additional devices connected to it.

FIG. 2 depicts one example of a computer system 110, according to one physical form factor. As shown in FIG. 2, the computer system 110 comprises a computer per se 205 and detachable external hardware circuitry 210. The computer 205 is shown as a laptop or notebook type computer but it could be a desktop, handheld (e.g., Smartphone) or any other type of computer. The computer 205 includes a local display screen 215 and one or more input devices such as a keyboard and/or pointer device (not shown). Also illustrated in FIG. 2 is a keyboard key 220. When a user wishes to activate the external hardware circuitry 210 and thereby enable sharing of his or her computer display screen 215, he or she can press the keyboard key 220. Alternatively, he or she can activate an input device such as a mouse pointer (not shown) on the computer 205 or a remote control that connects to the media adapter 130 or other A/V device (e.g. PlayStation® 3 remote control) to accomplish the same effect.

Because data compression and related processing can sometimes be a computationally intensive process, it can be desirable to offload some or all of that processing from the computer 205's internal CPU (central processing unit) to the dedicated hardware circuitry 210 or other hardware, such as a GPU (Graphics Processing Unit) (not shown). As shown, the hardware circuitry 210 is a plug-in card in a plug-in card slot 225. This physical form factor is suitable for an after-market retrofit embodiment. However, other physical form factors are possible. For example, hardware circuitry could be provided on an internal add-on card suitable for optional installation by an OEM (original equipment manufacturer); alternatively, the hardware circuitry could be provided on a dongle that plugs into a data interface port on the computer 205; or, the hardware circuitry could be provided on a device that connects by a cable to a video monitor output interface of the computer 205 to accept display screen data and also connects by a cable to data interface port of the computer 205 to send processed video data back to the computer 205. These various example embodiments are illustrated and described more fully in patent application Ser. No. 12/182,929.

The plug-in card slot 220 may be of any type, such as for example, PCMCIA (Personal Computer Manufacturer Interface Adaptor), Cardbus, or Expresscard. Alternatively, the slot 220 could be a USB (Universal Serial Bus) receptacle or a PCI (Peripheral Component Interconnect) or PCIe (PCI Express) interface.

FIG. 2 also illustrates a user-adjustable box 230 on the local display screen 215. The box 230 represents a selected portion of the local display screen 215 that the user desires to share, as described above.

FIG. 3 is a high-level block diagram of the computer system 110 illustrated in FIG. 2. FIG. 3 shows some of the more pertinent components of the computer 205 and the external hardware circuitry 210 employed in generating a data stream suitable for transmission as depicted in FIG. 1, according to the physical form factor shown in FIG. 2. In this embodiment, computer display graphics data is routed on an internal computer 230 bus and provided to the external hardware circuitry 210 through the plug-in card slot 225. As shown in FIG. 3, the external hardware circuitry 210 comprises a compressor 305 and an interface 310, which connects to the card slot 225.

Included within the computer 205 is a frame buffer 235 that preferably stores pixel-level graphics data for the local display screen 215. When a user presses the keyboard key 220 on the computer 205, the interface 310 within the external hardware circuitry 210 accesses the graphics data stored in the frame buffer and provides it to the compressor 305, which compresses the graphics data to create a data stream that can accommodate the bandwidth limitations imposed by the transmission channel 120 and the maximum allowable data rate of the media adapter 130. Following compression, the compressed and otherwise processed media stream is returned to the computer 205 via the same interface 310. The media stream is then wirelessly transmitted via a wireless transmitter 240 to the media adapter 130.

Also included within the computer 205 is a media file 270, which the computer 205 can alternatively send to the media adapter 130, rather than the media stream built by the computer 205 to represent the local display screen 215 and related data. The media file 270 is typically already compressed and formatted in a manner supported by the media adapter 130. Thus, the media file may not need to be processed like the local display screen graphics data.

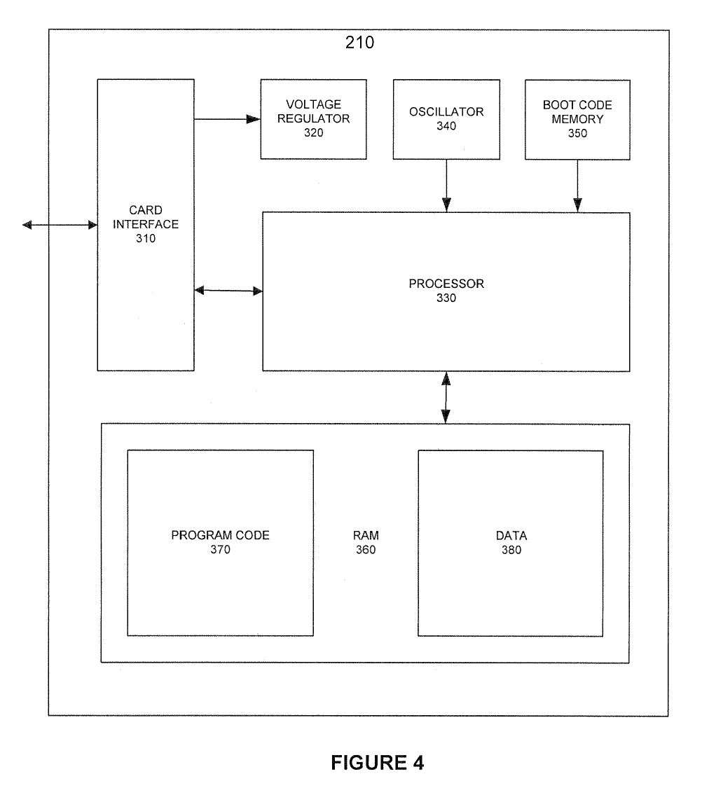

FIG. 4 is a block diagram of some of the more pertinent components of the external hardware circuitry 210, according to one embodiment. In addition to the card interface 310, the hardware circuitry 210 also may comprise a voltage regulator 320. As shown, the voltage regulator 320 receives a power signal from the card interface 310. If a power signal is not available from the expansion card, then the hardware circuitry 210 may alternatively comprise a separate power connection or its own power supply coupled to a power source (e.g., a battery). The voltage regulator 320 provides power to the other components of the hardware circuitry 210 via power connections not shown.

The hardware circuitry 210 also comprises a processor 330 that performs the compression and in one implementation any other processing necessary to convert display screen graphics data into a suitable media stream. That additional processing may alternatively be done in the computer 205. The processor 330 may be, for example, a microprocessor, DSP (Digital Signal Processor), programmable array (e.g., FPGA (Field-Programmable Gate Array)) or an ASIC (Application-Specific Integrated Circuit). The processor 330 is typically a single chip but it may comprise multiple chips. The hardware circuitry also comprises an oscillator 340 that generates a clock signal for the processor 330 and any other clock signals needed by the hardware circuitry 210. A boot code memory 350 stores boot code for the processor 330. The boot code memory 350 may be ROM (read-only memory), for example. The hardware circuitry 210 also comprises RAM (random-access memory) 360 that may store both program code 370 and data 380. The RAM 360 is preferably high-speed memory, such as DDR2 (Double Data Rate 2) or DDR3 (Double Data Rate 3) type synchronous dynamic RAM. The data 380 in the RAM 360 may include temporarily stored graphics or other input data, algorithm parameters, and intermediate or final results generated by the processor 330. The program code 370 in the RAM 360 may store executable source code program instructions that implement the compression and any other processing algorithms performed by the processor 330.

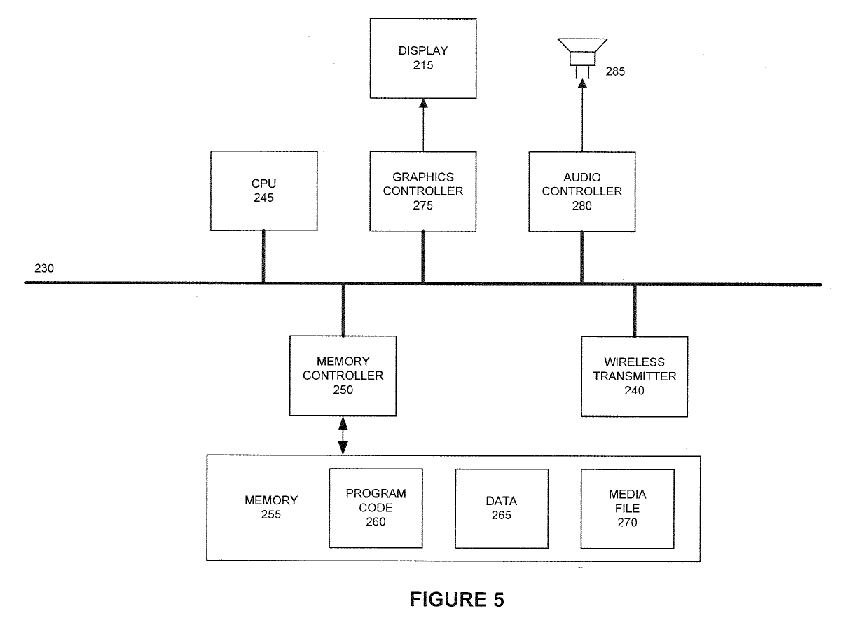

FIGS. 2-4 illustrate various aspects of examples in which the processing to create a media stream suitable for transmission to the media adaptor 130 is performed in dedicated hardware. Alternatively, that processing can be implemented in software executing on the CPU or a GPU of the computer 205. One example of a computer 205 with software processing of the operative functionality is illustrated in the simplified computer architecture diagram in FIG. 5. As shown in FIG. 5, a computer 205 comprises the bus 230 and a CPU 245 (which may be one or more processors, shown for simplicity as one processor). With a sufficiently fast and powerful CPU 245 or GPU (not shown), the computer 205 can perform the necessary processing. If the frame rate, resolution and/or selected window size are decreased or if only audio data is processed, then a less powerful CPU 245 may be adequate. In other words, performance can be traded off for computational power, thereby enabling an implementation without additional hardware.

FIG. 5 illustrates some of the components and subsystems typically found in a computer. The following describes those components and subsystems in so far as they are pertinent to the intended operation of the computer 205 in the system 100 (FIG. 1). To create and process a media stream from raw graphics and audio data, the computer 205 is equipped with compression software. The software is an executable file specifically designed to generate a data stream compliant with a desired compression standard, such as an MPEG standard. The software is typically stored on a disk accessible by a data storage controller. On startup, a kernel-level device driver typically assists the data storage controller to read the program from the data storage device. The computer 205's operating system then relies on a memory controller 250 to store the program contents into CPU accessible primary memory 255 (typically RAM). The memory 255 thereby includes program code 260 and associated program data 265 that are then accessible by the CPU 245 via the memory controller 250 such that computer instructions for processing can be executed.

The memory 255 may also include one or more media files, such as the media file 270, which can also be sent to the media adapter 130 for remote playing, rather than the display screen data, according to the techniques described herein. Typical media files have content protection features to limit unauthorized copying or distribution. For example, common content protection features are encryption and digital rights management (DRM). Sending to the media adapter 130 a content-protected media file itself, when selected, rather than the desktop, is a preferred approach for several reasons. First, that approach is consistent with and permissible under typical current DRM, as many media adapters have the capability to handle content-protected media files. Utilizing that inherent capabilities of the media adapter 130 is efficient. Second, this approach is desirable from a usability standpoint. According to this approach, the user may be watching the content protected video in a single window occupying a portion of the desktop, but what appears on the remote display device 140 is not the full desktop with a content protected window but the content protected video itself. If someone is watching a movie on their laptop and wants to display it on a wide-audience display screen, then it is natural that the default operation should be to send the movie to the big screen and continue to show the desktop display on the notebook. Thus, when the media file 270 is played on the remote display device 140, it may be neither a clone nor an extension of the local display screen 215.

Once loaded and executed, the processing software program would await an input from a user input interface, preferably activated by either a keyboard or pointer device, such as a mouse. The user input interface signals to the processing software that the user would like to start (or stop) displaying his or her local display screen, or a portion thereof, and/or associated audio on a remote wide-audience display, such as the display device 140 (FIG. 1). Whenever the user wishes to initiate display of his or her computer screen by entering the appropriate input, the software program starts to sample data from a graphics controller 275, which typically includes the frame buffer 235 (FIG. 3) storing data that is used to drive the local display 215, at a suitable frame rate and resolution (i.e. appropriate for the hardware (CPU/GPU/Network/Display) being used).

As the graphics data is sampled and buffered, the processing software generates suitable frames and performs compression processing. When an MPEG compression standard is utilized, the processing software generates MPEG compatible frames, compresses the frame data, and stores the data into an MPEG compatible format. The MPEG standard and other compression standards also support the ability to encode mixed media data, so the processing software can also sample an audio controller 280 for any audio data that would normally be played on a computer speaker 285. The AN data can then be combined to form a single media stream which can be transmitted by means of the wireless transmitter 240 for reception by the media adapter 130 (FIG. 1). Alternatively, in an audio-only mode, only the audio data can be compressed and packaged into a suitable media stream. Although the wireless transmitter 240 is shown as a wireless transmitter in FIG. 5, it may alternatively be a network interface to a wired network on which the media adapter 130 is connected.

Although FIG. 5 depicts a single bus 230 and a single CPU 245, that is done for simplicity of presentation. Multiple buses connected by bus bridges may be employed, as may be multiple processors.

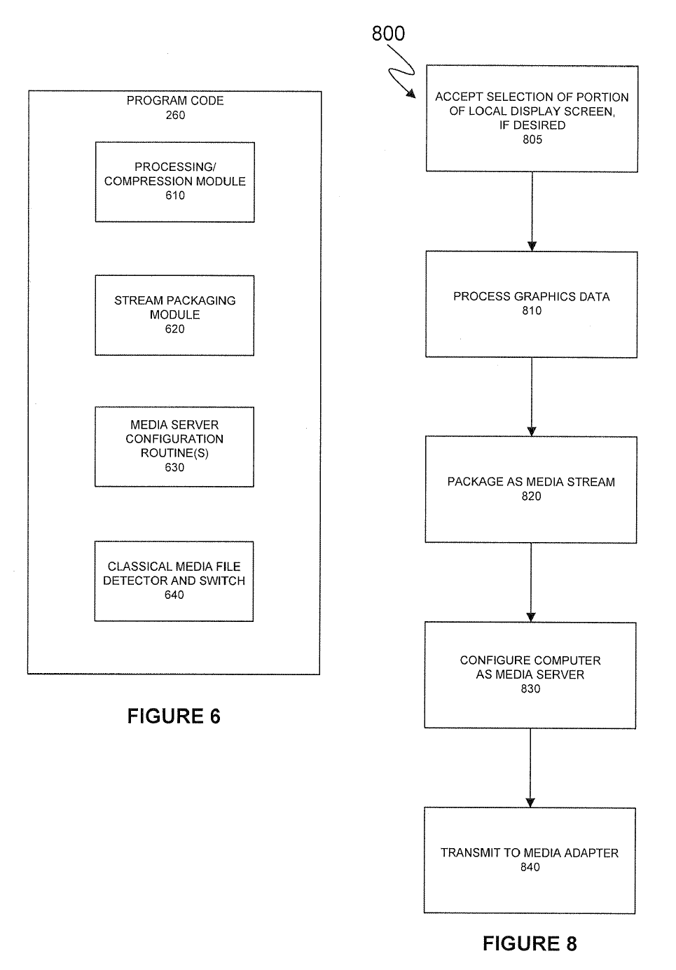

FIG. 6 is a computer memory diagram showing software modules and routines in the program code 260, according to one embodiment. Included in the memory is a processing/compression module 610 that processes the display screen graphics data, preferably on the fly as it is generated. The processing includes compression according to an algorithm supported by the target media adaptor 130 as well as any pre- or post-processing. Optionally, the processing/compression module or a separate module may also compress audio data generated by the computer 205 and normally played on a local speaker or speaker set at the computer 205. Also included is a stream packaging module 620 that packages the processed graphics data as a media stream. The stream packaging module 620 may also combine processed audio data, if any, into the media stream. Additionally, one or more media server configuration routines 630 set up the computer 205 as a media server. Finally, a classical media file detector and switch 640 may be included in the program code 260. The classical media file detector and switch 640 is a module that detects when a user of the computer 205 opens a classical media file, such as the media file 270. The classical media file detector and switch 640 may be a task or procedure that executes in the background. The classical media file detector and switch 640 may key off the file type to detect a known classical media file type, or detect operation of a recognized media viewer program executing on the computer 205. When such a file selection or activation is detected by any means, the classical media file detector and switch 640 switches or selects the classical media file to be sent to the media adaptor rather than the local display screen data.

Although the processing/compression module 610, the stream packaging module 620, the media server configuration routine(s) 630, and the classical media file detector and switch 640 are shown together in FIG. 6, they may be distributed in different memories in a computer system. For example, one or both of the stream packaging module 620 and the media server configuration routine(s) 630 may be in the main memory of the computer 205 (e.g., the memory 255), while the processing/compression module 610 may be stored in memory that is part of dedicated hardware (e.g., the RAM 360 in FIG. 4). In other words, the processing/compression module 610 may execute on a dedicated processor, while the less computationally demanding other routines may execute on the CPU 245 of the computer 205.

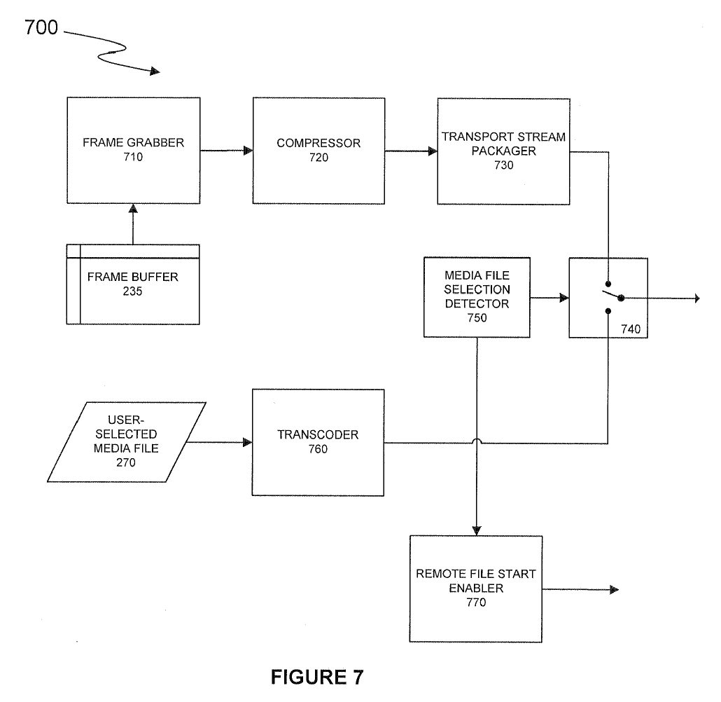

FIG. 7 is a block diagram of a system 700, which comprises aspects of the computer system 110 that operate to switch between two modes: (1) A local display screen masquerading mode and (2) a mode for playing classical media files. The system 700 comprises a frame grabber 710 that grabs frames of uncompressed graphics data from the frame buffer 235 or other screen graphics data source and supplies those frames to a compressor 720, which generates compressed frames, which are in turn sent to a transport stream packager 730, which generates a stream suitable for transmission to the media adapter 130.

The manufactured media stream exiting the transport stream packager 730 is supplied to one input of a selector switch 740, which is set either to pass that manufactured media stream along for transmission, such as by the transmitter 240, or to pass the user-selected classical media file 270 along for transmission. The setting of the switch 740 is established by a media file selection detector 750, which may be, for example, a background task that monitors for selection of a media file. Supported media files may be recognized by, for example, their file types as by indicated by the file extension in the file name. Alternatively, the media file selection detector 750 may comprise a routine to query the user, such as by displaying a dialog box asking the user if he or she would like to play the selected media file locally or remotely on the display device 140 and/or its associated sound system. The media file selection detector 750 may be configurable, such as by settings accessible through a control panel provided by the operating system of the computer 205, to enable or disable the verification query before proceeding with the selected media file.

When the media file selection detector 750 detects selection of the media file 270, with or without querying the user for verification, the detector 750 may optionally cause the compressor 720 and perhaps the frame grabber 710 and/or the transport stream packager 730 to be disabled or to enter a low-power state to conserve power and to minimize heat generation.

Unlike display screen graphics data, the media file 270 is typically already in a suitable form for receipt by the media adapter 130, as the media file 270 is already compressed and packaged as a media file. The media file 270 may nonetheless undergo some processing before it is transmitted to the media adapter 130. As shown in FIG. 7, for example, the media file 270 may be processed by a transcoder 760 to convert its coding into a format supported by the media adapter 130. Ideally, the media file 270 is already in a supported form and the transcoder 760 is not needed. In certain cases, however, the media file 270 may be in an incompatible format for the media adapter 130; in those cases the computer 110 can perform transcoding of the file 270 to put it into a format that is readable by the media adapter 130.

Additionally, the media file selection detector 750 may trigger a remote file start enabler 770 to setup the media adapter to receive and properly handle the media file 270. Several remote file starting techniques are possible. For example, the remote file start feature of UPnP can be used to command the media adapter to play the media file 270 automatically, without any additional user interaction. Remote file start is a control that the computer system 110 can send to a remote device, such as the media adapter 130, pursuant to the DLNA (Digital Living Network Alliance) standard. On media adapters that do not support UPnP remote file start, another technique is to invoke the user's manual assistance. For example, when the user selects the media file 270 on the computer system 110, the media adapter 130 would detect the presence of the file and display its title or other indicia so that the user could start the file via the media adapter's own user interface, such as by operation of a remote control or controller associated with the media adapter 130. Yet another technique useful with media adapters that do not support UPnP remote file start is to utilize other communication channels to initiate the playback of the file 270 as autonomously as possible. For example, if the media adapter 130 accepts control signals from an infrared or Bluetooth™ signal, and if the computer system 110 is capable of generating such a signal, then the computer 110 can generate a suitable signal to begin the playback. For example, this technique is possible with a PlayStation® 3 gaming system, as the media adapter, because it accepts Bluetooth™ signals from a game controller. In essence, the computer system 110 spoofs the media adapter 130 by acting like a game controller, according to this technique.

Functionally, the computer system 110 includes (1) means for processing the display screen graphics data as the graphics data is generated by the computer, wherein the processing includes compressing, to yield processed display screen graphics data in a compressed format supported by the media adapter, (2) means for packaging the processed display screen graphics data as a media stream, (3) means for configuring the computer to be a media server of the media stream to the media adapter, (4) means for transmitting the media stream from the computer to the media adapter, thereby facilitating display on the display device of the graphics content, substantially cloning or extending what appears on at least a portion of the display screen attached to the computer; and (5) means for when a user enters an input signifying a desire by the user to play a media file on the computer. The processing means can be a software or hardware module or a combination of hardware or software. The processing means includes compression circuitry or a software algorithm for compression, as well as any pre- or post-compression circuitry or routines. Examples of the processing means include the compressor 305 or 720 described above and the processing/compression module 610 in the program code 260. The packaging means can also be a software or hardware module and may be combined with the processing module. Software versions of the packaging means may execute on either the CPU 245 of the computer per se 205 or on the processor 330 included with the additional circuitry 210. The configuration means is typically software executing on the CPU 245 of the computer per se 205, but it also may execute on another processor. The transmitting means may be the wireless transmitter 460, which is typically included as part of a wireless modem or wireless network interface connection in most computers 205. Alternatively, the transmitting means may be part of network connection included as part of the computer 205 or provided in the additional hardware circuitry 210. The sensing means may be the media file selection detector 750 or all or part of the classical media file detector and switch module 640 in the program code 260.

### III. Methods and Processes

The systems, computers and devices described above and illustrated in various respects in FIGS. 1-7 are capable of performing various methods in hardware and/or software. Representative examples of such methods are described next with reference to FIGS. 8 and 9.

FIG. 8 is a simplified flowchart of a method 800 used to process local display screen graphics data into a media stream suitable for transmission to the media adapter 130, according to one embodiment. The method 800 may first perform an optional step 805 to determine whether the user desires to share the entire local display screen or just a portion of it, and if the latter, then accepting input from the user to select the desired portion. An example of a user-adjustable box 230 on the local display screen 215 is illustrated in FIG. 2.

The method 800 processes graphics data at step 810, whether that data represents the entire local display screen, just a portion thereof, or an extension thereof. The processing step 810 includes compressing the data, to yield processed display screen graphics data. According to one embodiment, the step 810 comprises sampling a raw video stream directly from a graphics controller frame buffer at a pre-configured refresh rate and resolution. Operating systems can provide direct access to the graphics data through proprietary application programming interfaces (APIs). Therefore, software programs running locally on the computer 110 can access the frame buffer directly and sample the pixel-level video data. In other embodiments, the video data is accessible through data interface ports including DVI or VGA ports. In these embodiments, a video receiver interface is required to convert the DVI or VGA signal into discrete video data samples. As sample frames (i.e., images) are buffered, a compression algorithm compresses the frames into an acceptable format and then places the compressed frames into a container, typically called an “elementary stream” for an MPEG format.

The processing step 810 can also process audio data, if present. According to one embodiment, this comprises sampling a raw audio stream directly from an audio controller or sound card to capture the audio signal sent to the local speaker(s) of the computer 110 and to compress it according to a suitable format.

As graphics and/or sound data is encoded and buffered, the method 800 then packages the processed data at step 820 as a media stream. When the H.264/AVC compression algorithm is employed, the step 820 involves packetization of the compressed data into an elementary stream. In one embodiment, the step 820 segments an elementary stream into groups of bits and attaches a packet header that identifies the particular elementary stream. The step 820 may be performed by a packetizer module, which may be implemented in hardware or software. The output of the packetizer is sometimes called a packet elementary stream (PES).

The method 800 also configures the computer 110 to be a media server at step 830. According to one embodiment, when a transport stream (TS) is ready for transport through the transmission channel, the method 800 initiates a file transfer, preferably using standard network protocols. The media adapter 130 can issue a hypertext transfer protocol (HTTP) request for the TS data. The computer 110 can respond with file header information and can then begin a real-time file stream. The configuring step 830 can be performed before, after, or simultaneously with the processing step 810 and/or the packaging step 820. As depicted in the final step 840 of the method 800, the TS packets are transmitted when they are processed and available for transport. According to one embodiment, the TS packets are transmitted in 188-byte groups.

The transmitting step 840 may transmit the entire media stream, just the video portion thereof or just the audio portion thereof. In an audio-only mode, in which the user desires to share only audio content, only the audio data is compressed and transmitted according to one embodiment. According to another embodiment, the video content is also transmitted but a separate control signal is also transmitted to the media adapter 130 to configure it not to display the video content.

FIGS. 9 is a flowchart of a method 900, according to an embodiment whereby the computer system 110 either (a) performs processing to masquerade local display screen data as a media stream and transmits the media stream to the media adapter or (b) transmits a media file to the media adapter without processing. The method 910 performs a monitoring step 910 by which it detects when the user selects a media file for opening. The monitoring step 910 may be implemented by a procedure executing in the background, for example. Alternatively, the monitoring step 910 may query the user, such as by popping up a dialog box asking the user if he or she would like to play the selected media file locally or remotely on the display device 140 and/or its associated sound system.

If no media file selection is detected by the monitoring step 910, the method 900 performs the screen masquerading process 800 described above in relation to FIG. 8 (assuming that the remote display mode is on). If, on the other hand, the monitoring step 910 detects selection of a media file or if the user selects the option to play the file remotely, then the method 900 configures the computer system 110 to be a media server, if necessary, as shown in step 920, which may be the same or similar to the media server configuration step 830 shown in FIG. 8. Next, the method 900 transmits the media file to the media adapter 130 at step 930. In audio-only mode, the transmitting step 930, like the transmitting step 840 in FIG. 8, may transmit just the audio content encoded in the media file. According to one embodiment, the media file is transmitted in its entirety and a separate control signal is also transmitted to the media adapter 130 to configure it not to display the video content. When the end of the media file is reached (step 940), the method 900 returns to the monitoring step 910. The method 900 can then repeat steps 920-940 when another media file is selected by the user.

The methods and systems illustrated and described herein can exist in a variety of forms both active and inactive. For example, they can exist partially or wholly as one or more software programs comprised of program instructions in source code, object code, executable code or other formats. Any of the above can be embodied in compressed or uncompressed form on a computer-readable medium, which include storage devices. Exemplary computer-readable storage devices include conventional computer system RAM (random access memory), ROM (read only memory), EPROM (erasable, programmable ROM), EEPROM (electrically erasable, programmable ROM), flash memory and magnetic or optical disks or tapes.

### IV. Conclusion

The terms and descriptions used above are set forth by way of illustration only and are not meant as limitations. Those skilled in the art will recognize that many variations, enhancements and modifications of the concepts described herein are possible without departing from the underlying principles of the invention. The scope of the invention should therefore be determined only by the following claims and their equivalents.

1. A method for selectively either (a) playing a media file accessed from a computer on a remote display device connected to a media adapter or (b) masquerading uncompressed pixel-level computer display screen graphics data as a media stream supported by the media adapter to cause the remote display device to substantially clone or extend what appears on at least a portion of a local display screen attached to the computer, the method comprising:
sensing when a user enters an input signifying a desire by the user to play a media file on the computer;
if said input is not sensed, then performing a masquerading process comprising:
processing the display screen graphics data as the graphics data is generated by the computer, wherein the processing includes compressing, to yield processed display screen graphics data in a compressed format supported by the media adapter;
packaging the processed display screen graphics data as a media stream;
configuring the computer to be a media server of the media stream to the media adapter; and
transmitting the media stream from the computer to the media adapter, thereby facilitating display on the remote display device of the graphics content; and
if said input is sensed, then performing a file transfer process comprising transmitting the media file from the computer to the media adapter, thereby facilitating display on the remote display device of the video content associated with the media file.

2. A method according to claim 1, wherein the remote display device is associated with a sound system, the media file comprises audio content, and transmitting the media file from the computer to the media adapter facilitates playing the audio content on the sound system.

3. A method according to claim 2, wherein the media file consists essentially of audio content.

4. A method according to claim 2, further comprising:
sensing when a user enters an audio-only input signifying a desire by the user to play only the audio content on the sound system associated with the remote display device; and
if said audio-only input is sensed, then sending a control signal to the media adapter to disable display of the video content on the remote display device while allowing playback of the audio content on the sound system associated with the remote display device.

5. A method according to claim 1, wherein the remote display device is associated with a sound system, and wherein the masquerading process further comprises:
processing system audio data generated by the computer during normal operation of the computer, wherein the processing includes compressing, to yield processed audio data in a compressed format supported by the media adapter; and
packaging the processed audio data as part of the media stream.

6. A method according to claim 5, further comprising:
sensing when a user enters an audio-only input signifying a desire by the user to play only the audio content on the sound system associated with the remote display device; and
if said audio-only input is sensed, then additionally performing the following step as part of the masquerading process:
sending a control signal to the media adapter to disable display of the video content on the remote display device while allowing playback of the audio content on the sound system associated with the remote display device.

7. A method according to claim 1, wherein the media adapter is at least part of a device separate from the remote display device.

8. A method according to claim 7, wherein the device of which the media adapter is a part is a gaming system.

9. A method according to claim 1, wherein the transmitting step comprises transmitting the media stream from the computer to the media adapter through at least one wireless link.

10. A method according to claim 9, wherein the media file is encrypted.

11. A method according to claim 1, wherein the computer and the media adapter are connected by and communicate via a local area network.

12. A method according to claim 11, wherein the local area network operates with at least one wireless link according to an IEEE 802.11 standard.

13. A method according to claim 1, wherein the computer and the media adapter communicate via an Internet protocol.

14. A method according to claim 1, wherein the sensing step is performed by a background task executing on the computer.

15. A method according to claim 14, wherein the file transfer process further comprises:
performing a remote file start operation.

16. A method according to claim 14, wherein the file transfer process further comprises:
causing the media adaptor to prompt the user, via a user interface of the media adapter, to initiate playing the media file.

17. A method according to claim 14, wherein the file transfer process further comprises:
transmitting a wireless signal from the computer to the media adaptor to trigger the media adapter to initiate playing the media file.

18. A method according to claim 17, wherein the wireless signal is an infrared signal.

19. A method according to claim 17, wherein the wireless signal conforms to a Bluetooth™ protocol.

20. A method according to claim 1, wherein the file transfer process comprises transcoding the media file prior to transmitting the media file from the computer to the media adapter.

21. A system for selectively either (a) playing a media file accessed from a computer on a remote display device connected to a media adapter or (b) masquerading uncompressed pixel-level computer display screen graphics data as a media stream supported by the media adapter to cause the remote display device to substantially clone or extend what appears on at least a portion of a local display screen attached to the computer, the system comprising:
means for processing the display screen graphics data as the graphics data is generated by the computer, wherein the processing includes compressing, to yield processed display screen graphics data in a compressed format supported by the media adapter;
means for packaging the processed display screen graphics data as a media stream; and
means for configuring the computer to be a media server of the media stream to the media adapter;
means for sensing when a user enters an input signifying a desire by the user to play a media file on the computer; and
means for transmitting from the computer to the media adapter either (a) the media stream, thereby facilitating display on the remote display device of the graphics content, or (b) the media file, thereby facilitating display on the remote display device of the video content associated with the media file, wherein a decision to transmit either the media stream or the media file is based on an output of the means for sensing.

22. A computer readable medium on which are embedded software code that performs a method for selectively either (a) playing a media file accessed from a computer on a remote display device connected to a media adapter or (b) masquerading uncompressed pixel-level computer display screen graphics data as a media stream supported by the media adapter to cause the remote display device to substantially clone or extend what appears on at least a portion of a local display screen attached to the computer, the method comprising:
sensing when a user enters an input signifying a desire by the user to play a media file on the computer;
if said input is not sensed, then performing a masquerading process comprising:
processing the display screen graphics data as the graphics data is generated by the computer, wherein the processing includes compressing, to yield processed display screen graphics data in a compressed format supported by the media adapter;
packaging the processed display screen graphics data as a media stream;
configuring the computer to be a media server of the media stream to the media adapter; and
transmitting the media stream from the computer to the media adapter, thereby facilitating display on the remote display device of the graphics content; and
if said input is sensed, then performing a file transfer process comprising transmitting the media file from the computer to the media adapter, thereby facilitating display on the remote display device of the video content associated with the media file

23. A computer system comprising:
a frame buffer in which is stored pixel-level display screen graphics data;
a local display screen connected to the frame buffer, wherein images represented by the pixel-level display screen graphics data in the frame buffer are displayable on the local display screen when the computer system operates in a normal display mode;
a module that processes the display screen graphics data as the graphics data is generated, wherein the processing includes compressing, to yield processed display screen graphics data in a compressed format supported by a media adapter connected to a remote display device;
a module that packages the processed display screen graphics data as a media stream;
software that configures the computer to be a media server of the media stream to the media adapter;
memory storing a media file;
a transmitter that transmits to the media adapter either (a) the media stream, thereby substantially cloning or extending what appears on at least a portion of the local display screen on the remote display device, or (b) the media file, thereby causing the media adapter to play the media file on the remote display device; and
a module that detects selection of the media file by the user and directs the media file to the transmitter if opened by the user but otherwise directs the media stream to the transmitter.

24. A computer system according to claim 23, further comprising:
the media adapter.

25. A computer system according to claim 24, further comprising:
the remote display device.

26. A computer system according to claim 23, further comprising:
a module that initiates a remote file start procedure on the media adapter according a UPnP protocol.

27. A computer system according to claim 23, wherein the media adapter comprises a user interface, and wherein playing of the media file is begun by an action of the user in the user interface of the media adapter.

28. A computer system according to claim 23, further comprising:
a second transmitter that transmits a wireless control signal to the media adapter, wherein the wireless control signal triggers the media adapter to initiate playing the media file.

29. A computer system according to claim 28, wherein the wireless control signal is an infrared signal.

30. A computer system according to claim 28, wherein the wireless control signal conforms to a Bluetooth™ protocol.

31. A computer system according to claim 23, further comprising:
a transcoder configured to change encoding of the media file, the transcoder producing an output media file that is conveyed to the transmitter.

32. A computer system according to claim 23, wherein the remote display device is associated with a sound system, the media file comprises audio content, and transmitting the media file from the computer to the media adapter facilitates playing the audio content on the sound system.

33. A computer system according to claim 32, wherein the media file consists essentially of audio content.

34. A computer system according to claim 32, further comprising:
a module that senses when a user enters an audio-only input signifying a desire by the user to play only the audio content on the sound system associated with the remote display device; and
a transmitter that sends a control signal to the media adapter to disable display of the video content on the remote display device while allowing playback of the audio content on the sound system associated with the remote display device.

35. A computer system according to claim 23, wherein the remote display device is associated with a sound system, and wherein the computer system further comprises:
a module that processes system audio data generated by the computer during normal operation of the computer, wherein the processing includes compressing, to yield processed audio data in a compressed format supported by the media adapter; and
a module that packages the processed audio data as part of the media stream.

36. A computer system according to claim 35, further comprising:
a module that senses when a user enters an audio-only input signifying a desire by the user to play only the audio content on the sound system associated with the remote display device, wherein, if said audio-only input is sensed, then the computer sends a control signal to the media adapter to disable display of the video content on the remote display device while allowing playback of the audio content on the sound system associated with the remote display device.

37. A method for masquerading a selected portion of uncompressed pixel-level computer display screen graphics data as a media stream supported by a media adapter connected to a remote display device, so as to cause the remote display device to display what appears on the selected portion of a local display screen attached to the computer, the method comprising:
accepting a user-defined selection of a portion of the local display screen;
processing display screen graphics data associated with the user-defined selection, as the graphics data is generated by the computer, wherein the processing includes compressing, to yield processed display screen graphics data in a compressed format supported by the media adapter;
packaging the processed display screen graphics data as a media stream;
configuring the computer to be a media server of the media stream to the media adapter; and
transmitting the media stream from the computer to the media adapter, thereby facilitating display on the display device of the graphics content.

38. A method according to claim 37, wherein the accepting step comprises:
accepting a rectangular box framing the user-defined selection of the portion of the local display screen; and
rendering the rectangular box on the local display screen to indicate the user-defined selection.

39. A method according to claim 38, wherein the box resembles a television.

40. A method according to claim 38, wherein the box comprises indicia suggesting that it represents a television screen.

41. A method for selectively playing on an A/V presentation device connected to a media adapter either (a) audio content of a media file accessed from a computer or (b) system audio content generated by operation of the computer, the method comprising:
sensing when a user enters an input signifying a desire by the user to play a media file on the computer;
if said input is not sensed, then performing a masquerading process comprising:
processing system audio data generated by the computer during normal operation of the computer, wherein the processing includes compressing, to yield processed audio data in a compressed format supported by the media adapter;
packaging the processed audio data as a media stream;
configuring the computer to be a media server of the media stream to the media adapter; and
transmitting the media stream from the computer to the media adapter, thereby facilitating playback on the A/V presentation device of the audio content; and
if said input is sensed, then performing a file transfer process comprising transmitting the media file from the computer to the media adapter, thereby facilitating playback on the A/V presentation device of the audio content associated with the media file.

42. A method according to claim 41, wherein the media file consists essentially of audio content.

43. A method according to claim 41, wherein the media file comprises A/V content.

44. A method according to claim 43, wherein the file transfer process further comprises:
transmitting the media file comprising both audio and visual content; and
transmitting from the computer to the media adapter a control signal to cause the media adapter to configure the A/V presentation device to play only the audio content while not displaying the visual content.

45. A method according to claim 41, wherein the system audio content is associated with graphics data, and wherein the processing comprises separating the audio content from the graphics data, such that the processed audio data does not contain graphics data, whereby the transmitting step of the masquerading process transmits the audio content while not transmitting the graphics data.
